(19) United States
(12) Patent Application Publication
(10) Pub. No.: US 2026/0363488 A1
(43) Pub. Date: Nov. 19, 2026

(54) MULTI-FUNCTIONAL FOOD PROCESSOR

(71) Applicant: Changzhou Mr Wheat electric appliance Co., Ltd., Changzhou (CN)

(72) Inventors: Yufeng QIAN, Changzhou (CN); Xiang LIU, Changzhou (CN); Wei FU, Changzhou (CN); Haoren BAO, Changzhou (CN)

(21) Appl. No.: 19/407,605

(22) Filed: Dec. 3, 2025

(30) Foreign Application Priority Data
May 16, 2025 (CN) 202520974233.5

(51) Int. Cl. A47J 43/25; A47J 47/00

(52) U.S. Cl. CPC A47J 43/25; A47J 47/00

(57) ABSTRACT

A multi-functional food processor includes a container body, a cover body, a shredding assembly and a press-cutting assembly, where the cover body is located on the container body and has a function replacement port, the shredding assembly includes a shredding blade set, the press-cutting assembly includes a press-cutting blade set and a pressing member, and the shredding blade set and the press-cutting blade set can be alternatively installed in the function replacement port; the cover body is further provided with multi-purpose side holes, the shredding blade set is provided with a latch capable of being snap-connected to the above-mentioned multi-purpose side hole, and the pressing member is provided with a guide plate capable of guiding and cooperating with an insert of the above-mentioned multi-purpose side hole.

### CROSS-REFERENCE TO RELATED APPLICATION

The present application claims the benefit and priority of the Chinese Patent Application No. CN202520974233.5 entitled "MULTI-FUNCTIONAL FOOD PROCESSOR", filed on May 16, 2025, which is herein incorporated by reference in its as part of the application.

### TECHNICAL FIELD

The present disclosure relates to a food cutting and cooking tool, and more particularly, to a multi-functional food processor.

### Background Art

At present, various types of food cutters have been widely used in daily food processing, making operations such as shredding, slicing, and dicing ingredients simple and efficient. A flat-plane shredding cutter represents the most common structure of food cutters, which cuts ingredients by sliding them against a shredding blade and is primarily used for shredding and slicing. Dicing is mainly achieved using a grid cutter, where ingredients are pressed to be cut by the grid cutter to get dices or cubes. At present, most dicing tools are single-function food cutters. To meet the requirements of daily food processing, users often need to purchase multiple cutter products, which not only increases purchasing costs but also complicates storage.

To address these issues, there are multi-functional food cutters in the prior art that are capable of shredding, slicing, and dicing, such as: “Multi-functional food Separator” disclosed in Chinese Patent Publication No. CN106956316A, “Multi-functional food Cutter” disclosed in Chinese Patent Publication No. CN210704951U, “Multi-functional Fruit and food Processor” disclosed in Chinese Patent Publication No. CN221265970U, and “Multi-functional food Cutting Tool Assembly and food Cutter” disclosed in Chinese Patent Publication No. CN221496373U. These prior art solutions achieve functional switching, e.g., shredding, slicing, and dicing by replacing different accessories, thereby partially addressing the issue of single- function cutters. However, they still exhibit the following shortcomings:

1. All the above-mentioned prior art adopts a rotary pressing method for dicing. Since the direction of force applied to the ingredients is not fully aligned with the cutting direction of the grid blade, significant press-cutting resistance is generated, making the dicing process labor-intensive.
2. Some prior art solutions (e.g., the “Multi-functional Food Cutting Tool Assembly and Food Cutter” disclosed in CN221496373U) require replacing the entire box lid along with accessories, resulting in a large number of components and relatively high manufacturing costs. Other solutions employ a detachable press cover design, but the replacement process necessitates installation or removal of the press cover hinge shaft, leading to operational complexity. Moreover, if the press cover is not removed during shredding or slicing operations, its open state may adversely interfere with the back-and-forth shredding operation.

In view of the above-mentioned deficiencies in the prior art, there is a need for improvements to enhance the practicality and user convenience of multi-functional food cutters.

### SUMMARY

### 1. Technical problem to be solved by the present disclosure

An objective of the present disclosure is to overcome the above-mentioned disadvantages of the prior art and provide a multi-functional food processor. With the technical solution of the present disclosure, a cover body is provided with a function replacement port and a multi-purpose side hole capable of replacing different cutting assemblies, a shredding assembly and a press-cutting assembly that can be perfectly matched by using the same cover body, wherein the shredding assembly can be fixed by using the multi-purpose side hole, and a pressing member of the press-cutting assembly can press foods along the guide of the multi-purpose side hole. The operations of disassembling and replacing the shredding assembly and the press-cutting assembly are simple and convenient as there is no interference between different cutting modes, and the press-cutting operation is easy and labor-saving; in addition, the number of parts required is small, and the manufacturing cost is low.

### 2. Technical solution

In order to achieve the above-mentioned objective, the present disclosure provides the following technical solutions:
a multi-functional food processor including a container body, a cover body, a shredding assembly and a press-cutting assembly, where the cover body is provided on the container body and has a function replacement port, the shredding assembly includes a shredding blade set, the press-cutting assembly includes a press-cutting blade set and a pressing member, and the shredding blade set and the press-cutting blade set can be alternatively installed in the function replacement port;
the cover body is further provided with multi-purpose side holes, the shredding blade set is provided with a latch capable of being snap-connected to the above-mentioned multi-purpose side hole, and the pressing member is provided with a guide plate capable of guiding and cooperating with an insert of the above-mentioned multi-purpose side hole.

Furthermore, a lower part of the shredding blade set has a mounting base which can be inserted into the above-mentioned function replacement port, and an upper part of the shredding blade set has a shredding blade; when the shredding blade set is installed in the function replacement port, an upper end face of the shredding blade set is substantially flush with a working face of the cover body;

a lower part of the press-cutting blade set has a mounting part which can be inserted into the above-mentioned function replacement port, the mounting part has a grid cutter therein, and an upper part of the mounting part has a feed cylinder; a lower part of the pressing member is provided with a pressing block which can protrude into the feed cylinder and is matched with the grid cutter, and the pressing direction of the pressing member is consistent with the cutting direction of the grid cutter.

A limiting flange is further provided at a lower part of the function replacement port.

Additionally, the multi-purpose side holes are respectively provided at two sides of the function replacement port, and are respectively arranged at the left and right sides of a shredding channel of the shredding blade set; the latches are respectively provided at one or two sides of the shredding blade set; the guide plates are also provided on each side of the pressing member, respectively.

The shredding assembly further includes a hand guard, and the shredding blade set has a detachable shredding blade.

Furthermore, an upper edge of the container body has a male stop, an edge of the cover body has a female stop adapted to the above-mentioned male stop, and the female stop located at the multi-purpose side hole is a double-stop structure.

A limiting step located at a root of the male stop is further located on an outer wall of the container body.

The container body is further provided with a bearing platform which can be overlapped with a back face of the cover body.

The container body has a reinforcing support extending downward from the bearing platform.

Furthermore, the container body is a rectangular box body structure, wherein the two ends of the container body have gripping grooves, and the side walls of the two ends of the container body have draining holes.

### 3. Advantageous effects

The technical solution provided by the present disclosure has the following advantageous effects compared with the known technology:

(1) A multi-functional food processor including a container body, a cover body, a shredding assembly and a press-cutting assembly, where the cover body is located on the container body and has a function replacement port, the shredding assembly includes a shredding blade set, the press-cutting assembly includes a press-cutting blade set and a pressing member, and the shredding blade set and the press-cutting blade set can be alternatively installed in the function replacement port; the cover body is further provided with multi-purpose side holes, the shredding blade set is provided with a latch capable of being snap-connected to the above-mentioned multi-purpose side hole, and the pressing member is provided with a guide plate capable of guiding and cooperating with an insert of the above- mentioned multi-purpose side hole, the same cover body can be used to perfectly match the shredding assembly and the press-cutting assembly, the multi-purpose side hole is used for one hole, the shredding assembly can be fixed using the multi-purpose side hole, the pressing member of the press-cutting assembly can press the food along the guide of the multi-purpose side hole, the operations of disassembling and replacing the shredding assembly and the press-cutting assembly are simple and convenient, there is no interference between different cutting modes, and the press-cutting operation is easy and labor-saving,.Compared with the prior art, the functions of shredding, slicing and dicing of food materials can be achieved by using fewer accessories, and the manufacturing cost is relatively lower;
(2) For a multi-functional food processor of the present disclosure, a lower part of the shredding blade set has a mounting base which can be inserted into the above-mentioned function replacement port, and an upper part of the shredding blade set has a shredding blade; when the shredding blade set is installed in the function replacement port, an upper end face of the shredding blade set is substantially flush with a working face of the cover body; the shredding blade set can be located using the function replacement port; the shredding blade set is located by cooperating with the fastening of the latch and the multi-purpose side hole to ensure the installation stability of the shredding blade set; and the working face of the cover body is used to extend a stroke of the shredding operation so as to make the shredding operation more convenient;
(3) For a multi-functional food processor of the present disclosure, a lower part of the press-cutting blade set has a mounting part which can be inserted into the above-mentioned function replacement port, the mounting part has a grid cutter therein, and an upper part of the mounting part has a feed cylinder; a lower part of the pressing member is provided with a pressing block which can protrude into the feed cylinder and is matched with the grid cutter, and the pressing direction of the pressing member is consistent with the cutting direction of the grid cutter, the pressing blade set can be supported and fixed using a function replacement port, and at the same time, under the guiding action of the guide plate, the pressing force is kept consistent with the cutting direction of the grid cutter, so that the press-cutting operation is easier and more convenient;
(4) For a multi-functional food processor of the present disclosure, a limiting flange is further provided at a lower part of the function replacement port, which can further improve the support of the press-cutting blade set and the shredding blade set and ensure the stability of the cutting structure;
(5) For a multi-functional food processor of the present disclosure, the multi-purpose side holes are respectively provided at two sides of the function replacement port, and are respectively arranged at the left and right sides of a shredding channel of the shredding blade set; the latches are respectively provided at one or two sides of the shredding blade set; the guide plates are also provided on each side of the pressing member, respectively; two sets of multi-purpose side holes are designed to further ensure the installation stability of the shredding blade set on the cover body and the guiding stability of the pressing member and the cover body;
(6) For a multi-functional food processor of the present disclosure, the shredding assembly further includes a hand guard to improve the safety of the shredding operation; the shredding blade set has a detachable shredding blade, which can achieve the functions of shredding and slicing by replacing different types of shredding blades;
(7) For a multi-functional food processor of the present disclosure, an upper edge of the container body has a male stop, an edge of the cover body has a female stop adapted to the above-mentioned male stop, and the female stop located at the multi-purpose side hole is a double-stop structure, wherein the cover body and the container body are matched using the stop structure to ensure effectivematching stability,and the operation stability of food cutting can be effectively improved;
(8) For a multi-functional food processor of the present disclosure, a limiting step located at a root of the male stop is further located at an outer wall of the container body, and the limiting step can play a certain supporting role on the cover body to further improve the matching stability of the cover body and the container body;
(9) For a multi-functional food processor of the present disclosure, the container body is further provided with a bearing platform capable of overlapping and matching with the back face of the cover body, and the bearing platform can play a supporting role for the cover body and improve the pressure resistance and anti-flapping capability of the cover body; furthermore, the container body is further provided with a reinforcing support extending downward from the bearing platform, which improves the structural strength of the container body and further improves the support reliability of the cover body; and
(10) For a multi-functional food processor of the present disclosure, the container body is a rectangular box body structure, wherein the two ends of the container body are further provided with gripping grooves, so that the food processor can be used more flexibly and conveniently; and the side walls of the two ends of the container body are also provided with draining holes, which can facilitate the cleaning and draining of the cut foods in the container body.

### BRIEF DESCRIPTION OF THE DRAWINGS

FIG. 1 is a schematic structural diagram illustrating a configuration of a multi-functional food processor according to the present disclosure;

FIG. 2 is a schematic structural diagram illustrating a combination of a container body and a cover body in a multi-functional food processor according to the present disclosure;

FIG. 3 is a cross-sectional schematic structural diagram taken along a line A-A in FIG. 2;

FIG. 4 is a schematic structural diagram illustrating a disassembled configuration of a cover body and a container body in a multi-functional food processor according to the present disclosure;

FIG. 5 is a schematic structural diagram illustrating a multi-functional food processor used as a slicing function according to the present disclosure (the hand guard is separated);

FIG. 6 is a schematic diagram illustrating an integrally assembled state in which a multi-functional food processor is used as a slicing function according to the present disclosure;

FIG. 7 is a cross-sectional schematic structural diagram taken along a line B-B in FIG. 6;

FIG. 8 is a schematic structural diagram illustrating an overall exploded configuration of a multi-functional food processor used as a slicing function according to the present disclosure;

FIG. 9 is a schematic structural diagram illustrating a multi-functional food processor used as a press-cutting function according to the present disclosure (the pressing member is separated);

FIG. 10 is a schematic diagram illustrating an integrally assembled state in which a multi-functional food processor is used as a press-cutting function according to the present disclosure;

FIG. 11 is a cross-sectional schematic structural diagram taken along a line C-C in FIG. 10; and

FIG. 12 is a schematic structural diagram illustrating an overall dissembled configuration of a multi-functional food processor as a press-cutting function according to the present disclosure.

### Introduction to reference numerals in the schematic diagrams:

1. container body; 1-1. reinforcing support; 1-2. male stop; 1-3. limiting step; 1-4. bearing platform; 1-5. gripping groove; 1-6. draining hole; 2. cover body; 2-1. function replacement port; 2-2. multi-purpose side hole; 2-3. limiting flange; 2-4. working face; 2-5. female stop; 3. shredding assembly; 3-1. shredding blade set; 3-1a. cutter mounting hole; 3-1-1. mounting base; 3-1-2. latch; 3-1-3. shredding blade; 3-2. hand guard; 4. press-cutting assembly; 4-1. press-cutting blade set; 4-1-1. mounting part; 4-1-2. feed cylinder; 4-1-3. grid cutter; 4-2. pressing member; 4-2-1. guide plate.

### DETAILED DESCRIPTION

For a further understanding of the present disclosure, reference is made to the accompanying drawings and examples.

### Embodiments

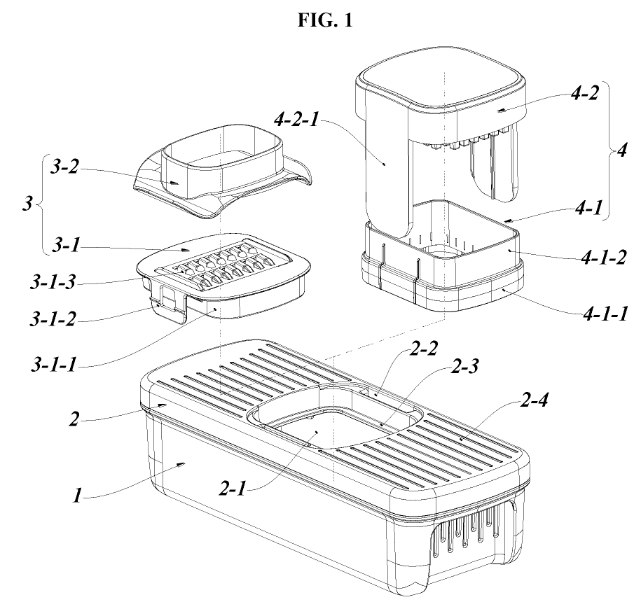

In view of what is shown in FIG. 1, the multi-functional food processor according to the present embodiment includes a container body 1, a cover body 2, a shredding assembly 3 and a press-cutting assembly 4, where the cover body 2 is provided on the container body 1, and the cover body 2 can be opened with respect to the container body 1; a function replacement port 2-1 is provided on the cover body 2, and the function replacement port 2-1 is preferably provided in the middle part of the cover body 2; the shredding assembly 3 and the press-cutting assembly 4 can be respectively provided in the function replacement port 2-1 so as to achieve the shredding and press-cutting functions; specifically, the shredding assembly 3 includes a shredding blade set 3-1, and the press-cutting assembly 4 includes a press-cutting blade set 4-1 and a pressing member 4-2; the shredding blade set 3-1 and the press-cutting blade set 4-1 can be alternatively installed in the function replacement port 2-1, that is to say, both the shredding blade set 3-1 and the press-cutting blade set 4-1 can be adapted to the function replacement port 2-1; after the shredding blade set 3-1 is installed in the function replacement port 2-1, the shredding operation of the food, such as slicing, shredding, etc. can be achieved; and after the press-cutting blade set 4-1 is installed in the function replacement port 2-1, the pressing member cutting operation of the food, such as dicing, cubing, etc. can be achieved. In the present embodiment, the cover body 2 is further provided with a multi-purpose side hole 2-2, where the multi-purpose side hole 2-2 is a through hole penetrating the cover body 2; the shredding blade set 3-1 is provided with a latch 3-1-2 capable of being snap-connected to the above-mentioned multi-purpose side hole 2-2, and the pressing member 4-2 is provided with a guide plate 4-2-1 capable of guiding and cooperating with an insert of the above-mentioned multi-purpose side hole 2-2; when the shredding blade set 3-1 is installed, the multi-purpose side hole 2-2 is used as a connection hole, so that the firmness of the installation of the shredding blade set 3-1 on the cover body 2 can be improved; when the press-cutting blade set 4-1 is installed, the multi-purpose side hole 2-2 serves as a guide hole capable of defining the pressing direction of the pressing member 4-2. In the multi-functional food processor of the present embodiment, the same cover body 2 can be used to perfectly match the shredding assembly 3 and the press-cutting assembly 4, the multi-purpose side hole 2-2 serves dual functions with a single aperture, the shredding assembly 3 can be fixed by using the multi-purpose side hole 2-2; a pressing member 4-2 of the press-cutting assembly 4 can press foods along the guide of the multi-purpose side hole 2-2; the operations of disassembling and replacing the shredding assembly 3 and the press-cutting assembly 4 are simple and convenient, there is no interference between different cutting modes, and the press-cutting operation is easy and labor-saving.

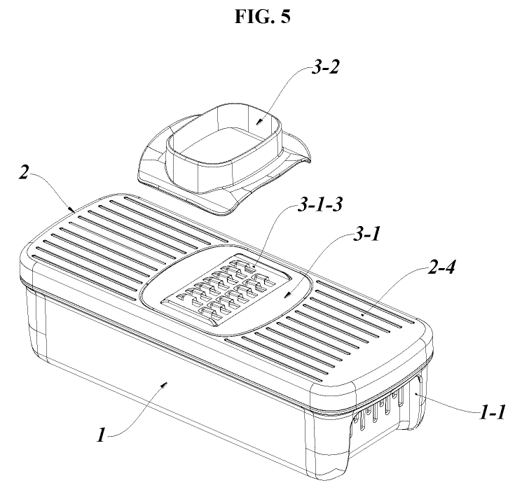

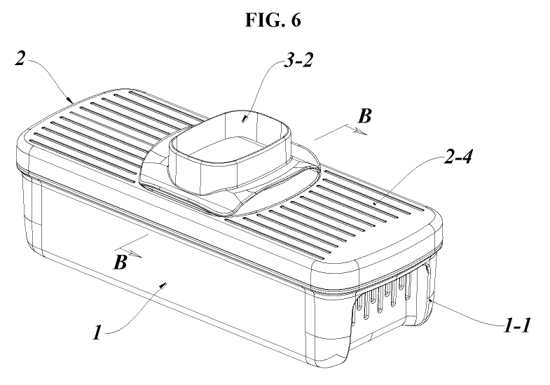

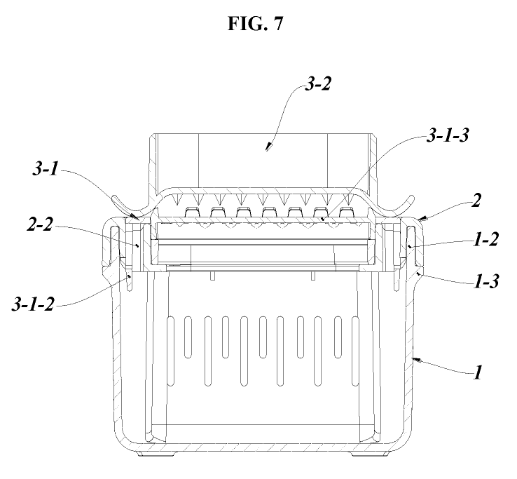

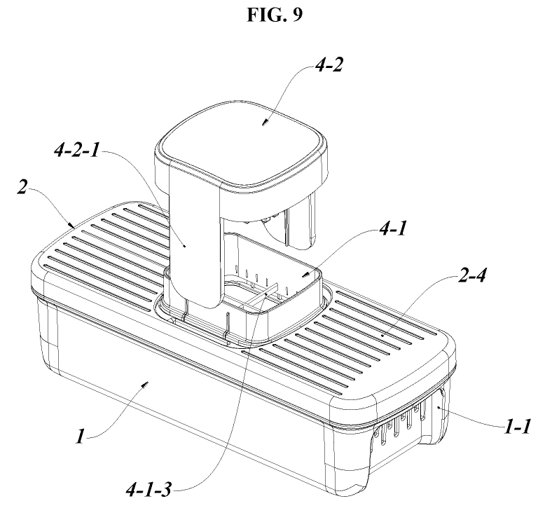

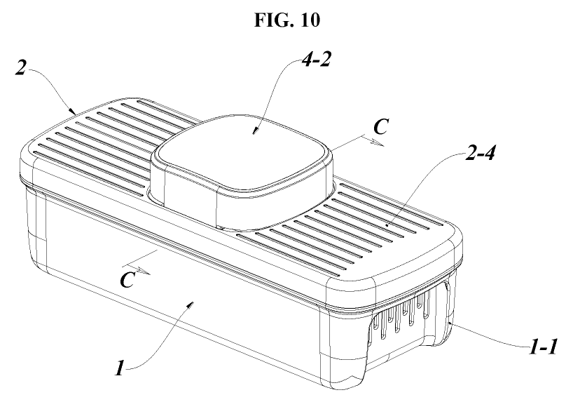

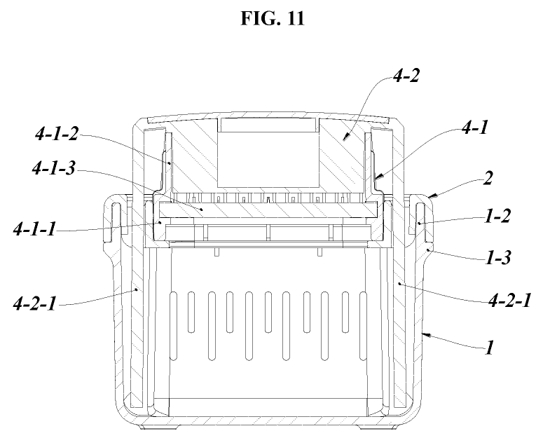

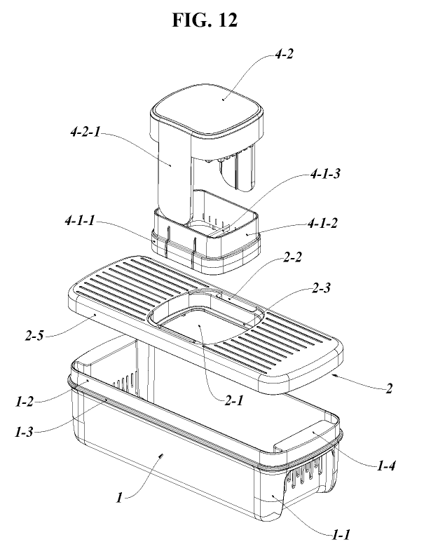

Referring to FIGS. 1-3, in another embodiment, the function replacement port 2-1 is of a sunken structure, and a plurality of reinforcing ribs are provided on the back face thereof to ensure the structural strength of the cover body 2. Accordingly, as shown in FIGS. 5-8, a lower part of the shredding blade set 3-1 has a mounting base 3-1-1 which can be inserted into the above-mentioned function replacement port 2-1, and an upper part of the shredding blade set 3-1 has a shredding blade 3-1-3; when the shredding blade set 3-1 is installed in the function replacement port 2-1, an upper end face of the shredding blade set 3-1 is substantially flush with a working face 2-1 of the cover body 2, and the shredding cutter 3-1-3 is located above the function replacement port 2-1, during the shredding operation, the food cut by the shredding cutter 3-1-3 falls into the container body 1. The function replacement port 2-1 can be used to locate the shredding blade set 3-1, and the shredding blade set is located by cooperating with the fastening of the latch 3-1-2 and the multi-purpose side hole 2-2 to ensure the installation stability of the shredding blade set 3-1; and the working face 2-4 of the cover body 2 is used to extend a stroke of the shredding operation so as to make the shredding operation more convenient. As shown in FIGS. 9-12,a lower part of the press-cutting blade set 4-1 has a mounting part 4-1-1 which can be inserted into the above-mentioned function replacement port 2-1, the mounting part 4-1-1 has a grid cutter 4-1-3 therein, and an upper part of the mounting part 4-1-1 has a feed cylinder 4-1-2; a lower part of the pressing member 4-2 is provided with a pressing block which can protrude into the feed cylinder 4-1-2 and is matched with the grid cutter 4-1-3, and the pressing direction of the pressing member 4-2 is consistent with the cutting direction of the grid cutter 4-1-3; during the press-cutting operation, the mounting part 4-1-1 of the pressing blade set 4-1 is loaded into the function replacement port 2-1, and at this moment, the grid cutter 4-1-3 is located in the function replacement port 2-1; foods are placed into the feed cylinder 4-1-2; the guide plate 4-2-1 of the pressing member 4-2 is inserted into the corresponding multi-purpose side hole 2-2; and the pressing member 4-2 is pressed down; the food in the feed cylinder 4-1-2 is pressed against the grid cutter 4-1-3 by means of the pressing block of the pressing member 4-2, and the food is cut into dices and cubes by the grid cutter 4-1-3 and falls into the container body 1 below. The function replacement port 2-1 can achieve the fixing and support of the press-cutting blade set 4-1, and at the same time, under the guiding action of the guide plate 4-2-1, the pressing force is kept consistent with the cutting direction of the grid cutter 4-1-3, so that the press cutting operation is easier and more convenient.

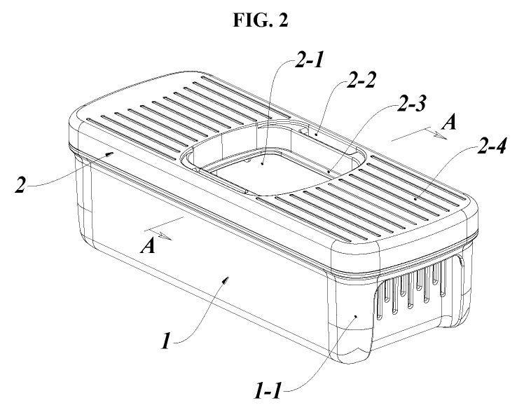

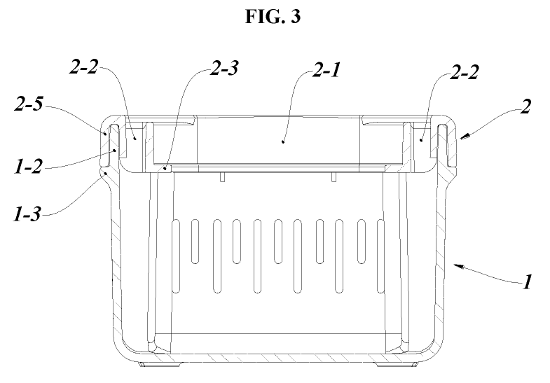

As shown in FIGS. 2 and 3, the lower part of the above-mentioned function replacement port 2-1 is further provided with a limiting flange 2-3, and the limiting flange 2-3 extends to the middle of the function replacement port 2-1, which can not only improve the structural strength of the function replacement port 2-1, but also further improve the support of the cutter press set 4-1 and the cutter shredding blade set 3-1 to ensure the stability of the cutting structure.

Referring to FIGS. 1-12, as a preferable design, in another embodiment, the multi-purpose side holes 2-2 are respectively provided at two sides of the function replacement port 2-1, and are respectively arranged at the left and right sides of a shredding channel of the shredding blade set 3-1. The latches 3-1-2 are respectively provided at one or two sides of the shredding blade set 3-1; the guide plates 4-2-1 are also provided on each side of the pressing member 4-2, respectively. The latch 3-1-2 is of a sheet-shaped structure and has a raised buckle thereon, and after the latch 3-1-2 is inserted into the corresponding multi-purpose side hole 2-2, the buckle on the latch 3-1-2 can snap-fit with the bottom of the multi-purpose side hole 2-2 to achieve the clamping and fixing of the two; when disassembled, the latch 3-1-2 can be dialed from the back face of the cover body 2 to disengage the buckle from the bottom of the multi-purpose side hole 2-2. The guide plate 4-2-1 is of a flat plate-like structure, has a cross-sectional shape adapted to the multi-purpose side hole 2-2, and can slide up and down in the multi-purpose side hole 2-2. By using the above-mentioned design of the left and right multi-purpose side holes 2-2, the installation stability of the shredding blade set 3-1 on the cover body 2 and the guiding stability of the pressing member 4-2 and the cover body 2 are further ensured.

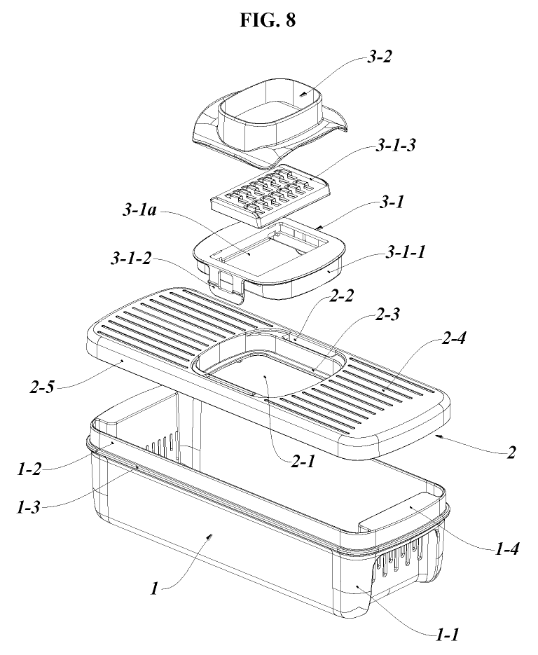

As shown in FIGS. 1 and 5-8, the shredding assembly 3 further includes a hand guard 3-2 to which the food can be fixed for a shredding operation, similar to the conventional shredding food cutter, so that the safety of the shredding operation is improved. The shredding blade 3-1-3 can be integrally formed on the shredding assembly 3 or can be detachably mounted on the shredding assembly 3 whereinthe latter is preferably used in the present embodiment. For example, the shredding blade set 3-1 has a detachable shredding blade 3-1-3, as shown in FIG. 8;in this case, a cutter mounting hole 3-1a is provided in the middle part of the mounting frame of the shredding blade set 3-1, the shredding blade 3-1-3 is detachably mounted in the cutter mounting hole 3-1a, and different functions, such as shredding and slicing, can be achieved by replacing different types of the shredding blades 3-1-3.

Referring to FIGS. 2-4, in yet another embodiment, an upper edge of the container body 1 has a male stop 1-2, an edge of the cover body 2 has a female stop 2-5 adapted to the above-mentioned male stop 1-2, wherein the cover body 2 and the container body 1 are matched by using the stop structure to ensurethe matching stability, and the operation stability of food cutting can be effectively improved. In addition, the female stop 2-5 located at the multi-purpose side hole 2-2 is of a double-stop structure (as shown in FIG. 3), the double-stop is of an “n”-shaped structure, and the male stop 1-2 can be clamped in the double-stop of the cover body 2, so that the cover body 2 is more tightly and stably fitted with the container body 1. In addition, a limiting step 1-3 located at the root of the male stop opening 1-2 is further located at the outer wall of the container body 1, wherein the limiting step 1-3 can be located around the periphery of the container body 1 in a circle, and the limiting step 1-3 can play a certain supporting role on the cover body 2 to further improve the matching stability of the cover body 2 and the container body 1.

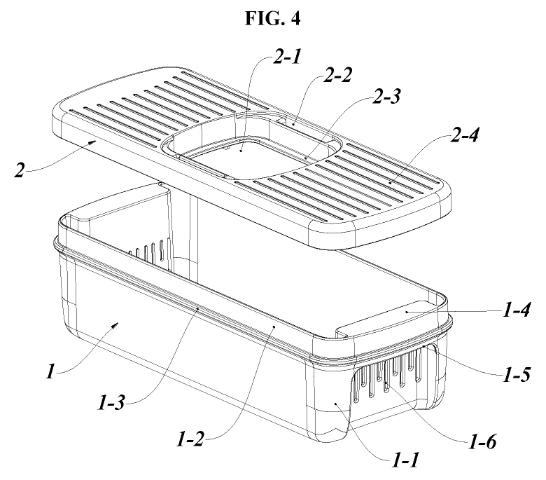

As shown in FIG. 4, in another embodiment, the container body 1 is further provided with bearing platforms 1-4 capable of overlapping and fitting with the back face of the cover body 2, and the bearing platforms 1-4 are capable of supporting the cover body 2 and improving the pressure resistance and flapping resistance of the cover body 2. Specifically, the bearing platforms 1-4 are provided at the front and rear ends of the container body 1, and when the cover body 2 is mounted on the container body 1, the bearing platforms 1-4 bear against the back face of the cover body 2 at this time, and play a supporting role for the cover body 2. Furthermore, the container body 1 is further provided with a reinforcing support 1-1 extending downward from the bearing platform 1-4. The reinforcing support 1-1 can be formed by recessing the outside of the bearing platform 1-4 inward. The side wall formed by the recess and the side wall of the container body 1 constitute the reinforcing support 1-1, which improves the structural strength of the container body 1 and further improves the support reliability of the cover body 2.

In addition, as shown in FIG. 4, in the present embodiment, the container body 1 is of a rectangular box body structure, two ends of the container body 1 are also provided with gripping grooves 1-5, and the gripping grooves 1-5 can be formed by the depression of the lower part of the above-mentioned bearing platform 1-4, so that the use of the food processor is more flexible and convenient; the side walls at the two ends of the container body 1 are further provided with draining holes 1-6, so that the cut food can be conveniently cleaned and drained in the container body 1.For example, after the food is cut, the cover body 2 can be opened, water is added into the container body 1 for cleaning or rinsing, and after the cleaning is completed, the container body 1 is cleaned by gripping the gripping groove 1-5 at one end, and the excess water can be poured out from the draining holes 1-6 at the other side.

FIGS. 5-8 are schematic structural diagrams showing a state in which the above-mentioned multi-functional food processor is used as a slicing function, where food is shredded, sliced, and the like by sliding the processor back and forth. FIGS. 9-12 are schematic structural diagrams showing a state in which the above-mentioned multi-functional food processor is used as a press-cutting function, where dicing or cubing is performed by pressing down the food, in such a manner that the press-cutting is easier and more labor-saving than the conventional flip cover press-cutting design. Of course, in addition to the above-mentioned conventional shredding assembly 3 and press-cutting assembly 4, other crushing assemblies may be designed to be used in view of the above-mentioned container body 1 and cover body 2, such as grinding of foods and the like, and the description thereof will not be repeated here.

For a multi-functional food processor of the present disclosure, a cover body is provided with a function replacement port and a multi-purpose side hole capable of replacing different cutting assemblies, a shredding assembly and a press-cutting assembly can be perfectly matched by using the same cover body, and the shredding assembly can be fixed by using the multi-purpose side hole; a pressing member of the press-cutting assembly can press foods along the guide of the multi-purpose side hole; the operations of disassembling and replacing the shredding assembly and the press-cutting assembly are simple and convenient. There is no interference between different cutting modes, and the press-cutting operation is easy and labor-saving; in addition, the number of parts required is small, and the manufacturing cost is low.

The above has schematically described the present disclosure and its embodiments. This description is not restrictive, and the illustrations in the drawings merely represent one of the embodiments of the present application. The actual structure is not limited thereto. Therefore, if a person skilled in the art are inspired by the present disclosure and, without departing from the spirit of the present application, design similar structural configurations and embodiments to the technical solution without creative efforts, such designs shall all fall within the protection scope of the present disclosure.

What is claimed is:

1. A multi-functional food processor, comprising a container body, a cover body, a shredding assembly and a press-cutting assembly,
wherein the cover body is provided on the container body and has a function replacement port, the shredding assembly comprises a shredding blade set, the press-cutting assembly comprises a press-cutting blade set and a pressing member, and the shredding blade set and the press-cutting blade set can be alternatively installed in the function replacement port; and
wherein the cover body is further provided with multi-purpose side holes, the shredding blade set is provided with a latch capable of being snap-connected to the multi-purpose side holes, and the pressing member is provided with a guide plate capable of guiding and cooperating with an insert of the multi-purpose side holes.

2. The multi-functional food processor according to claim 1,
wherein a lower part of the shredding blade set has a mounting base which can be inserted into the function replacement port, and an upper part of the shredding blade set has a shredding blade; when the shredding blade set is installed in the function replacement port, an upper end face of the shredding blade set is substantially flush with a working face of the cover body;
wherein a lower part of the press-cutting blade set has a mounting part which can be inserted into the function replacement port, the mounting part has a grid cutter therein, and an upper part of the mounting part has a feed cylinder; and
wherein a lower part of the pressing member is provided with a pressing block which can protrude into the feed cylinder and is matched with the grid cutter, and a pressing direction of the pressing member is consistent with a cutting direction of the grid cutter.

3. The multi-functional food processor according to claim 2, wherein a limiting flange is further provided at a lower part of the function replacement port.

4. The multi-functional food processor according to claim 1, wherein the multi-purpose side holes are respectively provided at two sides of the function replacement port, and are respectively arranged at left and right sides of a shredding channel of the shredding blade set; the latch is respectively provided at one or two sides of the shredding blade set; the guide plate is also provided on each side of the pressing member, respectively.

5. The multi-functional food processor according to claim 1, wherein the shredding assembly further comprises a hand guard and the shredding blade set which has a detachable shredding blade.

6. The multi-functional food processor according to claim 1, wherein an upper edge of the container body has a male stop, an edge of the cover body has a female stop adapted to the male stop, and the female stop located at the multi-purpose side holes is of a double-stop structure.

7. The multi-functional food processor according to claim 6, wherein a limiting step located at a root of the male stop is further located at an outer wall of the container body.

8. The multi-functional food processor according to claim 6, wherein the container body is further provided with a bearing platform which can be overlapped with a back face of the cover body.

9. The multi-functional food processor according to claim 8, wherein the container body is further provided with a reinforcing support extending downward from the bearing platform.

10. The multi-functional food processor according to claim 8, wherein the container body is of a rectangular box body structure, two ends of the container body are further provided with gripping grooves, and side walls of the two ends of the container body are further provided with draining holes.

11. The multi-functional food processor according to claim 2, wherein an upper edge of the container body has a male stop, an edge of the cover body has a female stop adapted to the male stop, and the female stop located at the multi-purpose side holes is of a double-stop structure.

12. The multi-functional food processor according to claim 3, wherein an upper edge of the container body has a male stop, an edge of the cover body has a female stop adapted to the male stop, and the female stop located at the multi-purpose side holes is of a double-stop structure.

13. The multi-functional food processor according to claim 4, wherein an upper edge of the container body has a male stop, an edge of the cover body has a female stop adapted to the male stop, and the female stop located at the multi-purpose side holes is of a double-stop structure.

14. The multi-functional food processor according to claim 5, wherein an upper edge of the container body has a male stop, an edge of the cover body has a female stop adapted to the male stop, and the female stop located at the multi-purpose side holes is of a double-stop structure.
